(19) United States
(12) Patent Application Publication
(10) Pub. No.: US 2009/0276246 A1
(43) Pub. Date: Nov. 5, 2009

(54) Automated Interdisciplinary Plan of Care Generation System

(75) Inventors: Robert Emmons Haskell, Chester Springs, PA (US); Carmela Anne Couderc, West Chester, PA (US); Susan Annette Matney, Woods Cross, UT (US); Mary Ellen Dlugos, King of Prussia, PA (US); Rebecca Rae DaDamio, Sinking Spring, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/433,471

(22) Filed: Apr. 30, 2009

Related U.S. Application Data
(60) Provisional application No. 61/049,468, filed on May 1, 2008.

(51) Int. Cl. G06Q 50/00; G06Q 99/00

(52) U.S. Cl. 705/3; 705/2; 705/10

(57) ABSTRACT

A processing device implemented system supports providing a plan of care for a patient. A repository includes data representing a plurality of different patient problems and including data representing an individual plan of care, indicating care to be provided to a specific patient, associated with a patient problem, an expected outcome, clinical observations, and orders for treatment to be administered to a patient. A data processor searches data in the repository to identify one or more candidate plans of care associated with a particular patient problem in response to user entry of data identifying the particular patient problem by searching data in the repository for a code associated with the particular patient problem. A display processor generates data representing at least one display image including data representing the one or more candidate plans of care associated with the particular patient problem enabling a user to select a particular plan of care for a particular patient.

An Automated Interdisciplinary Plan of Care Generation System This is a Nonprovisional Patent Application that claims priority from U.S. Provisional Patent Application Ser. No. 61/049,468 filed on May 1, 2008 by Robert Haskell et al.

### FIELD OF THE INVENTION

The invention concerns an automated interdisciplinary plan of care generation system for use in providing healthcare to a patient population.

### BACKGROUND OF THE INVENTION

The healthcare industry lacks a common industry reference model for patient care. Known plan of care systems do not support model-directed definitions of plans of care. Known systems utilize various components of a plan (nursing problems, goals, and interventions) to construct and document patient plans but these plans are not based on underlying models. The Healthcare Information Technology (HIT) systems that use particular terminologies do not require a model-based implementation, nor do they incorporate proprietary models. Existing nursing terminologies include nursing problems/diagnoses, but these problems/diagnoses are not based on underlying models. The international nursing informatics community has supported the development of models describing nursing diagnoses and nursing actions. These models are described by the International Organization of Standards (ISO) in document ISO 18104:2003. The International Council of Nurses (ICN) has embraced these ISO nursing models to create the International Classification of Nursing Practice (ICNP), which is described as a 7 Axis Model in ICNP Version 1.0. A known Hands-on Automated Nursing Data Systems (HANDS) application is comprised of the nursing terminologies NANDA (North American Nursing Diagnosis Association), NIC (Nursing Intervention Classification) and NOC (Nursing Outcomes Classification). This application supports links between the problems, interventions and outcomes at a pre-coordinated concept level only. It does not support decomposition of problems, interventions, and outcomes to basic values.

Known models for nursing diagnoses/problems are not sufficiently described to maximize their use and benefit within an operational HIT solution, such as an interdisciplinary plan of care application. The existing industry models have insufficient specificity of detailed attributes to support application requirements and insufficient supporting attribute properties to define application and user interface behavior. Additionally, simple text expressions of a nursing problem, expected outcome or intervention are insufficient to support an optimized nursing practice for individual patients at the point of care, as well as managing clinical outcomes for patient behavior.

Thus, in known systems, data is not easily shared across systems that do not use common and semantically consistent definitions. These systems do not include models to help promote consistent data usage across a healthcare enterprise or different enterprises. A system according to invention principles addresses these deficiencies and related problems.

### BRIEF SUMMARY OF THE INVENTION

A processing device implemented system provides a plan of care for a patient. A repository includes data representing a plurality of different non-patient specific plans of care associated with a plurality of different patient problems and including data representing an individual plan of care, indicating care to be provided to a specific patient, associated with a patient problem, an expected outcome, clinical observations, and orders for treatment to be administered to a patient. A data processor searches data in the repository to identify one or more candidate plans of care associated with a particular patient problem in response to user entry of data identifying the particular patient problem by searching data in the repository for a code associated with the particular patient problem. A display processor generates data representing at least one display image including data representing the one or more candidate plans of care associated with the particular patient problem enabling a user to select a particular plan of care for a particular patient.

### BRIEF DESCRIPTION OF THE DRAWINGS

FIG. 1 is a block diagram of the system for an automated interdisciplinary plan of care generation system according to invention principles;

FIG. 2 is a block diagram showing an automated interdisciplinary plan of care generation system and its interaction with a plurality of clinical applications according to invention principles;

FIG. 3 is a flow diagram showing the usage of the system for loading and creating a model based set of interdisciplinary plans of care for use in a clinical application according to invention principles;

FIG. 4 is a block diagram detailing the setup and interaction of metadata and attributes within the model according to invention principles;

FIG. 5 is a block diagram showing the structure of a plan of care model, including hierarchy of elements, and interrelationships, according to invention principles;

FIG. 6 is a block diagram displaying the general plan of care definition and the interaction between a particular plan of care template and its corresponding component parts, according to invention principles;

FIG. 7 is a block diagram displaying a plan of care definition model and how its components may be valued to create a plan of care definition instance according to invention principles;

FIGS. 8A-8E illustrate screenshots of the user interface used to load and define an interdisciplinary plan of care according to invention principles;

FIGS. 9A-9D illustrate screenshots of the user interface used to load and define an interdisciplinary plan of care according to invention principles;

FIG. 10 is an exemplary screen shot of the user interface used in defining an interdisciplinary plan of care according to invention principles;

FIG. 11 is an exemplary screen shot of the user interface used in defining an interdisciplinary plan of care according to invention principles;

FIG. 12 is an exemplary screen shot of the user interface used in defining an interdisciplinary plan of care according to invention principles; and

FIG. 13 is a flow diagram detailing system operation according to invention principles.

### DETAILED DESCRIPTION OF THE INVENTION

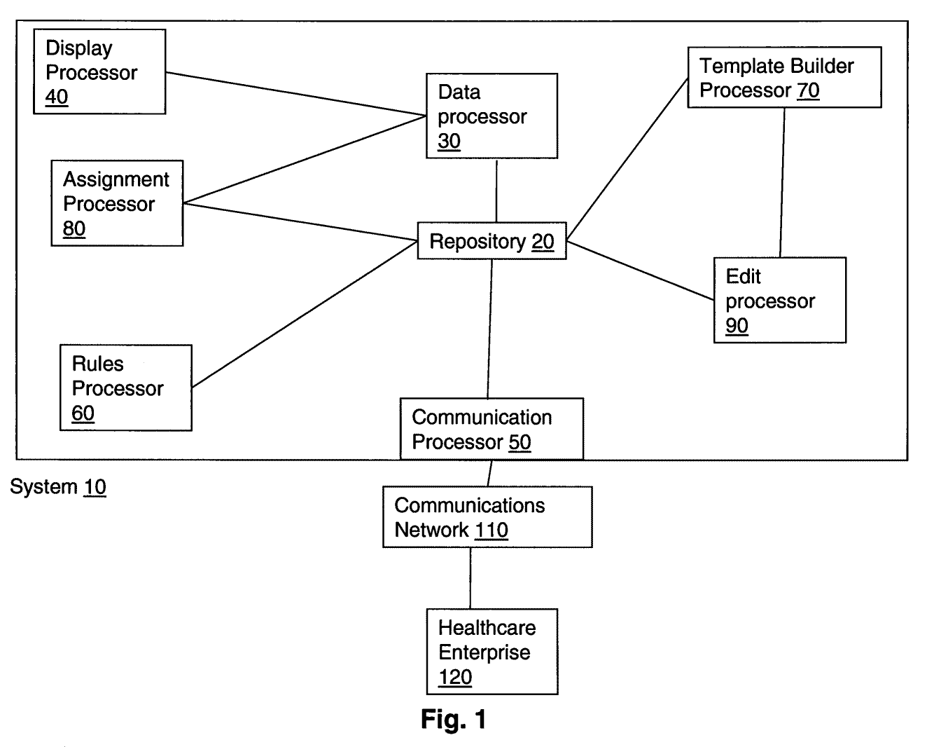

A system, as shown in FIG. 1, according to invention principles provides consistent, model-directed application and user interface behavior associated with the collection, translation, and interpretation of interdisciplinary plans of care. An interdisciplinary plan of care is a dynamic roadmap that outlines the process and procedure of care to be provided to a patient by any member of a clinical team within a healthcare enterprise. An interdisciplinary plan of care is an objective to be achieved by a nurse or other members of the clinical team to provide healthcare to a patient. For example, interdisciplinary plans of care alternatively are implemented by physicians' assistants, radiologist, phlebotomists or any other healthcare professional tasked to provide a service to a patient. The system includes a model structure including detailed attributes associated with interdisciplinary plans of care and supplemental information associated with interdisciplinary plans of care necessary to direct application behavior. The system further enables consistent data collection across applications. The system implements a model for use by a clinical application presented in a user interface which directs what data is collected, processed, and stored for secondary use. The system advantageously decomposes plans of care and their corresponding components into consistent, unambiguous, and computable definitions. This enables secondary data use based on specific component characteristics.

Because an interdisciplinary plan of care can be unambiguously and individually defined through the model, the data collected is semantically consistent and is easily shared within an interdisciplinary team caring for a patient, and aggregate clinical practice can be compared across clinical settings, “client” populations, geographic areas, or time periods. This model supports a total infrastructure used to create a “knowledge-directed” plan of care and electronic medical record (EMR) for use by a healthcare enterprise system. Thus, the system further advantageously provides a common industry reference model able to decompose plan of care components into a consistent, unambiguous, and computable definition for operational use within a clinical HIT application.

A single plan of care model, as provided by the system, provides:
A link between problems, interventions, and outcomes which are decomposed to the post-coordinated attribute values
A single definition, which may be customized to direct the behavior of any model-directed operational system, and can serve as the basis for consistent point of care data collection.
A single Interlingua, which is used to translate meaning between operational systems, between operational systems and external knowledge sources and translation between terminologies used by different systems.
A single dialog definition, which is used to define contextual constraints necessary to direct a clinical dialog (e.g., patient characteristics, other attribute values)
A single authoring definition, which is used to guide and constrain authoring dialogs for users defining new patient problems.

The system maps multiple clinical terminologies using a standard model which enables cross-application usage thereof. The system further advantageously provides a standard, application-independent structure (logical information model) that precisely describes the construction and definition of a unique, unambiguous, and computable plan of care. The model identifies the attributes and structure necessary to describe and define interdisciplinary plans of care in a form that may be used within a hospital information system in the context of a particular patient. The system utilizes model-directed application behavior wherein the structures and attributes of the clinical terms are defined and used in managing UI behavior and application business logic. These clinical terms structures and attributes are application independent, such that multiple applications can be managed from a single definition. The system advantageously provides a collection of standardized and structured data as a natural by-product of the end user computer dialog. Structured data is used to direct other system functions, (e.g., rule and workflow definitions, reporting and analysis, regulatory compliance), and to facilitate system interoperability.

Moreover, the system facilitates application migration from version to version or to new strategic applications. By externalizing the definition of clinical concepts into a standard model, the underlying clinical applications can be migrated with minimal effort. A result thereof is the improved integration of industry consensus into individual clinical solutions. Directing application behavior and data collection with common models, as opposed to software business logic, supports collaborative systems and interoperability.

Automated Interdisciplinary Plan of Care Generation System 10 (FIG. 1) provides a model structure and user interface facilitating consistent data collection, storage, and processing across different applications. System 10 identifies model structures, the detailed attributes within the model, the relationships between individual model components, and the supplemental information necessary to direct application behavior. The components of the model become the basis of a clinical application that uses it. As a result, this model directs what data is collected, processed, and stored for later secondary use. System 10 decomposes plans of care, as well as their corresponding components, into consistent, unambiguous, and computable definitions, which enables secondary data use based on specific component characteristics. The result is a standard universal model that can be used by any particular clinical application, and provides consistent data processing and storage. Particular uses of an individual model may differ between individual clinical applications. The model-directed functionality of System 10 facilitates efficient and consistent data sharing across a multitude of information systems, throughout and between different healthcare enterprises.

A block diagram for System 10 is shown in FIG. 1. An override function adapts a standard expected outcome definition based on the context (i.e., problem) to which it is associated. Variable parameters are defined for an expected outcome, which are resolved when the expected outcome is used. For example: (1) an expected outcome of walking xx feet, where the specific number of feet is substituted based on the plan of care or problem in which that expected outcome is used; or (2) the occurrence of a specific event or action that defines the desired outcome. However, the specific event or action depends on the problem to which the expected outcome is linked/attached. This prevents the same expected outcome from being defined many times with slight differences. The same capability applies to interventions/orders. A single definition can be modified based on the plan of care and problem to which it is assigned. Alternatively a single definition can be modified in response to genomic and proteomic data associated with any of particular patient or patient population. The genomic or proteomic data advantageously enables a highly specific definition of the expected outcome based on the molecular pathway of a particular clinical condition that is associated with the genomic or proteomic data.

The system supports categorizing plans of care (and also problems and expected outcomes) by a major body system, clinical specialty, or major disease groups. For example: (1) respiratory system and circulatory system plans of care are separately grouped; or (2) nursing, physician, cancer or heart disease plans of care of separately identified. Additionally, the plans of care are also categorized using at least one of (a) genomic data and (b) proteomic data. The categorizations using genomic or proteomic data can occur using one or both types of data. Therefore, particular users may be assigned certain categories, which advantageously facilitate filtering/limiting information to display for a particular user.

An executable application, as used herein, comprises code or machine readable instructions for conditioning a processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions stored on a computer readable medium to perform special purpose functions not performed by a general purpose computer. A processor may be coupled (electrically and/or as comprising executable components) with any other processor enabling interaction and/or communication there-between. A user interface processor or generator is a known element comprising electronic circuitry for generating display images or portions thereof. A user interface comprises one or more display images enabling user interaction with a processor or other device.

A user interface (UI), as used herein, comprises one or more display images, generated by a display processor and enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application manipulates the UI display images in response to the signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure. A document or record comprises a compilation of data in electronic or paper form.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition. The workflow engine includes a process definition function that allows users to define a process that is to be followed and includes an Event Monitor, which captures events occurring in a Healthcare Information System. A processor in the workflow engine tracks which processes are running, for which patients, and what step needs to be executed next, according to a process definition and includes a procedure for notifying clinicians of a task to be performed, through their worklists (task lists) and a procedure for allocating and assigning tasks to specific users or specific teams. A document or record comprises a compilation of data in electronic form and is the equivalent of a paper document and may comprise a single, self-contained unit of information.

Template builder processor 70 enables a user to generate data representing a template plan of care. A plan of care comprises a dynamic roadmap which outlines steps of care which are to be provided to a patient. A template plan of care comprises a plan of care which represents a model to be used for determining or interpreting a plurality of patient problems, expected outcomes, or observations/orders.

A repository 20, electrically coupled to template builder processor 70, stores: (1) data representing a plurality of different non-patient specific plans of care associated with a plurality of different patient problems; and (2) data representing a plurality of different template plans of care associated with a plurality of different patient problems. An individual plan of care or template plan of care stored in repository 20 includes data or component parts representing the care to be provided to a specific patient, associated with a patient problem, an expected outcome, clinical observations, and orders for treatment to be administered to a patient. A patient problem may be a nursing diagnosis, sign or symptom, finding, or risk factor. An expected outcome comprises an objective that is to be achieved within a given time period. A clinical observation is an assessment of a patient given by a healthcare professional. An order of treatment is a directive given by a healthcare professional regarding a specific task tailored towards providing treatment to a patient. The plan of care supports inter-disciplinary definition and management of patient problems, expected outcomes, clinical observations, and orders for treatment, in order to facilitate an optimized level of care necessary to achieve a desired outcome and to generate new knowledge of a patient problem of a patient.

Repository 20 includes, (a) data representing a set of plans of care including a plurality of different plans of care associated with at least one patient problem; (b) data representing a set of treatments to be administered to a patient in a plan of care associated with a particular patient problem; (c) data representing a set of clinical observations associated with a particular patient problem; and (d) data representing a set of patient problems associated with the individual plan of care.

In an alternate embodiment, repository 20 also includes data that associates patient demographic information with a plurality of different plans of care. The patient demographic information may include one or more of: (a) age, (b) gender, (c) weight, (d) height, and (e) pregnancy status. Repository 20 also supports storage and access to one or more databases.

In further embodiments, additional repositories are included within repository 20. For example, a first repository within repository 20 may include data representing a plurality of different non-patient specific plans of care associated with a plurality of different patient problems. A second repository includes data representing an individual plan of care, indicating the care to be provided to a specific patient, associated with a patient problem, an expected outcome, clinical observations, and orders for treatment to be administered to a patient. Separate repositories further facilitate efficient storage of data and reduces data redundancy.

System 10 further includes a data processor 30, electrically coupled to repository 20 for searching data in repository 20 to identify: (a) one or more candidate plans of care; and (b) one or more template candidate plans of care, associated with a particular patient problem in response to user entry of data identifying the particular patient problem by searching data in repository 20 for a code associated with the particular patient problem. A code comprises an alphanumeric identifier indicating a particular patient problem. Data processor 30 uses mapping information to map a particular patient problem to the code associated with the patient problem to identify the code associated with the particular patient problem. The code includes at least one of: (a) a concept name; and (b) a concept identifier. Usage of a code associated with a particular patient problem facilitates greater organization of patient and plan of care data. A particular concept is defined as the patient problem as a whole, including associated attributes and attribute properties. Attributes are data values associated with particular concepts and are identified and expressed in the model to facilitate operation of an application and/or a user interface. Attribute properties are data values associated with particular attributes of a particular concept and describe the desired application behavior for the attribute.

In addition, data processor 30 searches data in repository 20 to identify particular patient problems and one or more candidate plans of care associated with an identified patient problem by searching data in the repository in response to: (a) user entered data identifying a clinical observation; (b) user entered data identifying an expected outcome of patient treatment according to a plan of care; (c) user entered data identifying a treatment to be administered to a patient in a plan of care and (d) user entered data identifying patient demographic information. In response to the loading of a plan of care into System 10, data processor 30 facilitates user entered or automatic definition of component parts of a plan of care. Moreover, as repository 20 may support a plurality of repositories, data processor 30 may, for example, search data in a first and second repository to identify one or more candidate plans of care.

Additionally, data processor 30 automatically adaptively selects: (a) orders for treatment to be associated with a plan of care in response to context information; and (b) expected outcomes to be associated with a plan of care in response to context information. Context information comprises information describing the relationship between different data within a plan of care model. Context information includes at least one of: (a) patient specific clinical data, (b) patient specific demographic data, (c) type of plan of care, (d) patient specific genomic data and (e) patient specific proteomic data.

System 10 further includes display processor 40, electrically coupled to data processor 30 for generating data representing at least one display image including: (a) data representing one or more candidate plans of care; (b) data representing one or more candidate template plans of care; and (c) data representing a new template plan of care; associated with a particular patient problem to enable a user to select a particular plan of care for a particular patient. The data displayed in the at least one display image can also generate candidate plans of care based at least in part on patient genomic and/or proteomic data obtained from a patient.

A communication processor 50, electrically coupled to repository 20 and communications network 110, is conditioned for acquiring data representing interdisciplinary plans of care for storage in repository 20 and for sending data representing interdisciplinary plans of care to communications network 110. Acquired data is derived from any of repository 20 of System 10 or from a remote system in healthcare enterprise 120 via communications network 110. Acquired data may be acquired automatically from a source in response to an initiated executable procedure, an attribute property directing operation of an individual application, or in response to user input. Communication processor 50 is conditioned to assemble plan of care templates and associated components in System 10 for use in clinical applications, as well as to ensure that the stored plans of care are compatible with particular clinical applications. Data provided by repository 20 is communicated to healthcare enterprise 120 via communications network 110. Healthcare enterprise 120 includes different systems within a healthcare information system, for example, a clinical information system, workflow system and financial information system. Healthcare enterprises may include systems that are commonly operated by a single healthcare entity or systems operated by distinctly owned and operating healthcare providers. Data representing a plan of care is bidirectionally communicated between System 10 and healthcare enterprise 120. Communication occurs in response to a plan of care being loaded into System 10, in response to the definition and assemblage of component parts of a plan of care, such as problems, expected outcomes, and interventions/orders or in response to a plan of care being assigned to a patient within at least one clinical application of healthcare enterprise 120.

Rules processor 60 is electrically coupled to repository 20 to apply predetermined rules of different types associated with corresponding different patient problem characteristics in identifying one or more candidate plans of care associated with a particular patient problem. In response to loading of an interdisciplinary plan of care into System 10, rules processor 60 facilitates the association of an interdisciplinary plan of care with specific patient problems in order to provide optimal care for a particular patient's problem.

Assignment processor 80 is electrically coupled to repository 20 and data processor 30 assigns a particular user a particular category of plans of care or a particular category of patient problems based on at least one of: (a) user identification information; and (b) user role. For the purposes of assignment, plans or care are categorized by at least one of: (a) cancer type, (b) heart disease, (c) nursing; (d) physician specialty, (e) genomic marker, (f) proteomic marker and (g) molecular pathway associated with a clinical condition. These categorizations advantageously provide a higher specificity of classifications for particular diseases or ailments associated with a patient.

System 10 further includes edit processor 90, electrically coupled to template builder processor 70 and repository 20, enabling a user to edit a template of care accessed from repository 20 to create a new template plan of care for storage in repository 20. Edit processor 90 further enables a user to edit values representing: (a) expected outcomes; (b) clinical observations; or (c) orders for treatment to be administered to a patient, in a template plan or care to create a new template plan of care for storage in repository 20. Edit processor 90 additionally enables a user to edit a candidate template of care accessed from repository 20 to create a new template plan of care for storage in repository 20.

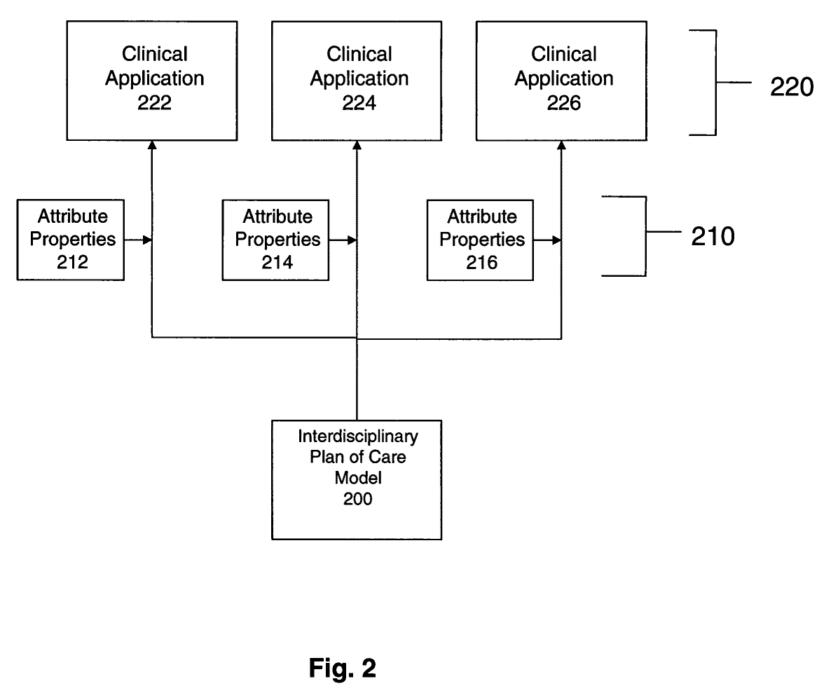

A block diagram showing an interdisciplinary plan of care model and its interaction with a plurality of clinical applications is shown in FIG. 2. Interdisciplinary plan of care model 200 is the common interdisciplinary plan of care stored in repository 20 of System 10 (FIG. 1). Interdisciplinary plan of care model 200 is used by a plurality of clinical applications 220. For example, clinical application 222 may be a radiology information system that uses data in model 200 for assigning a task to a particular worker to obtain an image study for a particular patient based on plan of care data. While FIG. 2 illustrates three clinical applications 222, 224, and 226, a different number of clinical or other applications that operate in a healthcare enterprise may be in communication with System 10 and able to use model 200 for presenting patient data in a desired manner or direct an application to operate in a specified manner. Model 200 includes data representing an interdisciplinary plan of care and associated component data, such as the patient problem, expected outcome, clinical observations, and orders for treatment to be administered. Attribute properties 210 are application specific attributes that specify how attributes within interdisciplinary plan of care model 200 are used by a particular clinical application. For example, a specific set of attribute properties 212 are used by clinical application 222. Clinical applications parse plan of care data to determine data values of attribute properties. The data values of attribute properties provide operating instructions to a respective clinical application directing operation of the clinical application or determining the manner in which the clinical application uses and presents plan of care data. Attribute properties 212 and 214 differ since they correspond to clinical applications 222 and 224 respectively and the use of model 200 within clinical applications 222 and 224 also differs. As a result, specific attribute properties are available for each particular plan of care to direct the application and determine user interface behavior. System 10 advantageously provides a repository of interdisciplinary plans of care that are selectively modifiable and expandable to enable a user to easily set attribute properties associated with a particular plan of care and which are useable by a plurality of different applications in a healthcare system.

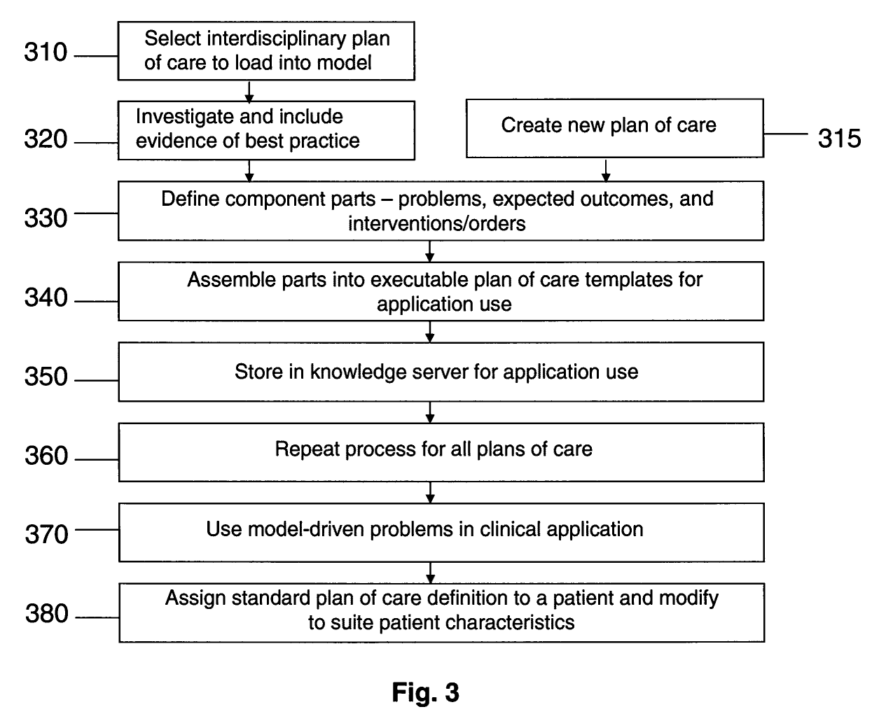

A flow diagram detailing the use of System 10 for loading a model based set of interdisciplinary plans of care for use in a clinical application is shown in FIG. 3. In step 310, a selected interdisciplinary plan of care is loaded into a model stored in repository 20 of System 10. Alternatively, step 315 supports user creation of a new interdisciplinary plan of care. Upon creation of a new interdisciplinary plan of care, the system moves to step 330. In response to loading a model, in step 320, System 10 investigates the interdisciplinary plan of care and associates the plan of care with corresponding patient problems to include evidence of best practice or identify which patient problem a particular plan of care is suited to remedy. In step 330, System 10 automatically or in response to user command, defines component parts of an interdisciplinary plan of care, such as problems, expected outcomes, and interventions/orders. Step 340 assembles the defined component parts into an executable plan of care template that can be used by a clinical application. Step 350 stores the plan of care template in a knowledge server or repository for later use by a clinical application. System operation continues at step 360 wherein the system repeats the operation detailed in steps 310-350 for the remaining plans of care to be loaded into System 10. When the process is complete for plans of care in step 360, step 360 allows a user or System 10 to specify attribute properties that correspond to the interdisciplinary plan of care to prepare the model for use in a particular clinical application. At step 370, after loading of the model to a particular clinical application, a user or System 10 may assign a standard plan of care definition to a patient and modify the plan of care, including component parts, accordingly to suit a particular patient's characteristics.

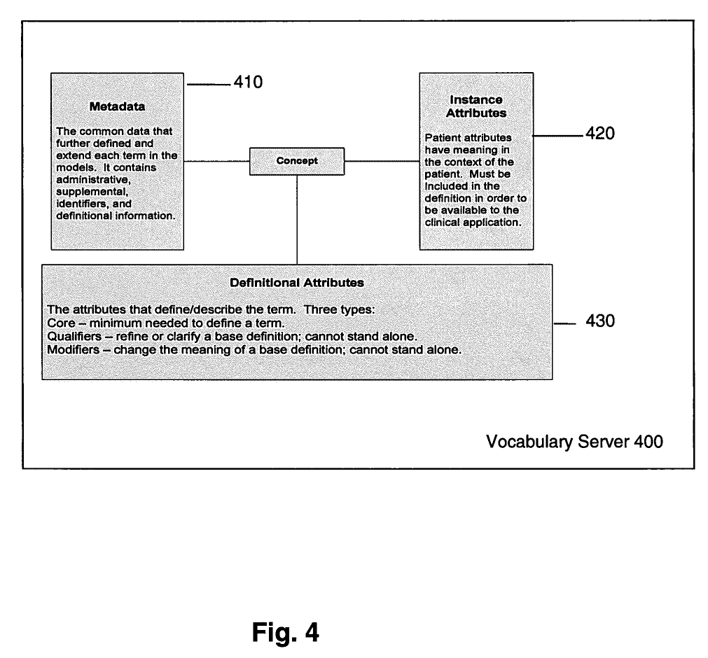

An individual plan of care is created using a vocabulary server 400 which defines components, attribute values, and properties that define and describe each problem and expected outcome. The structure of an exemplary interdisciplinary plan of care is shown in FIG. 4. The supporting structure created and stored in vocabulary server 400 is referred to as a definition instance. A particular clinical application searches and uses the definition instance for the creation of a patient instance of the plan of care. The patient instance is defined by the definition instance and includes additional attribute values and properties that are applicable when a plan of care is used to describe a patient phenomenon. The clinical application facilitates storage of the patient instance in the patient record of a particular patient.

Attributes, as shown in FIG. 4, include metadata 410, instance attributes 420, and definitional attributes 430. Attributes of an interdisciplinary plan of care model direct the clinical application, in this case, the patient record update system and corresponding user interface presented to an operator of the clinical application. Each clinical application is aware of what is defined in the central vocabulary server.

Patient instance attributes 420 and definitional attributes 430 are included in the models to support data-directed applications. Definitional attributes 430 describe the system, independent of any context in which it might utilized. Definitional attributes 430 are further subdivided into core attributes, which are required attributes needed for operation and are part of a pre-coordinated term.

Patient instance attributes 420 have meaning in relation to and in the context of a specific patient. Patient instance attributes 420 direct the user interface, which is the point where data is collected. Patient instance attributes 420 also include allowable value sets and characteristics of definitional attributes, which serve to direct clinical application operation and corresponding user interface.

Metadata attributes 410 are common data which further define and extend each concept in the models. Each problem, problem attribute, and problem attribute value is created as a unique concept within the general vocabulary server. Administrative information includes the source, version, status, create date/time, create user id, change date/time, change user id, review date/time, review user id, review comment, approval date/time, approval user id, and approval comment. Supplemental information includes a synonym or external reference value that correlates with at least one other element of plan of care data. Definitional information includes a concept type identifier, concept name, description, and text/text type. Metadata attributes 410 advantageously enable system expansion to allow later deployed clinical applications to interface with System 10 and utilize the model of plans of care to facilitate patient specific data collection and/or workflow modification of a healthcare worker tasked with providing a healthcare service to a particular patient using the clinical application. A particular concept is defined as the patient problem as a whole, including associated attributes and attribute properties.

System 10 is able to create and/or define existing plan of care data. Plan of care data includes data representing problems, expected outcomes, observations, and interventions/orders. A particular plan of care supports an inter-disciplinary team in defining and managing patient problems, expected outcomes, and interventions/orders in order to provide the patient care necessary to achieve a desired outcome.

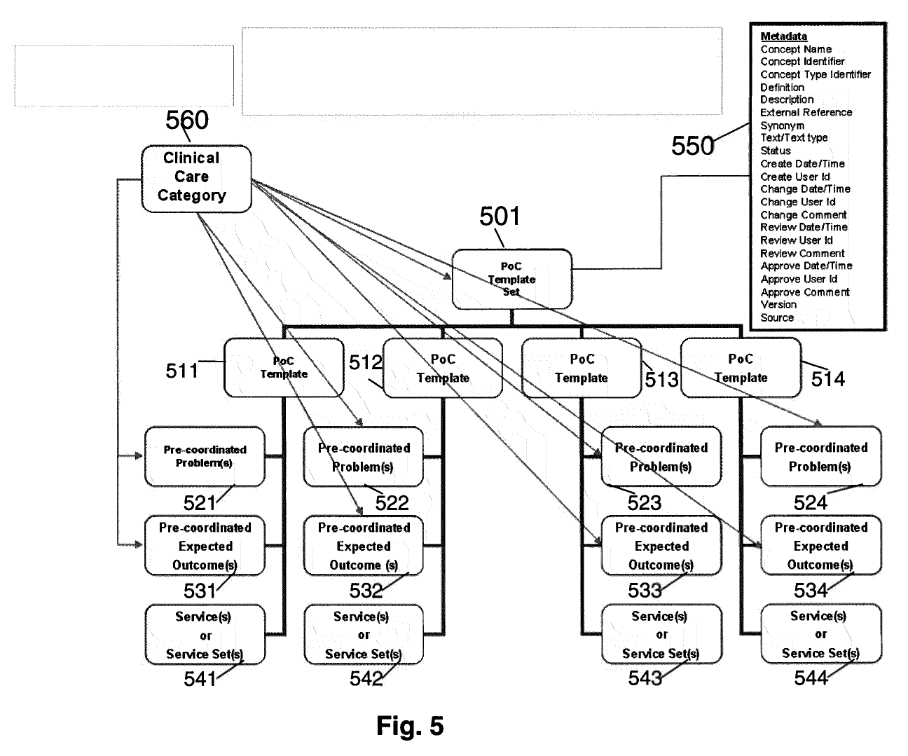

FIG. 5 shows an exemplary structure of a plan of care model definitional attributes. The model supports two concepts or scenarios: (1) A plan of care template; and (2) a plan of care template set. A plan of care template, such as plan of care templates 511-514, is a model or standard that provides a means for identifying and organizing the problems, expected outcomes, and interventions/orders that are necessary to address and work toward the resolution of a specific problem or a set of problems for a patient. A particular plan of care template is organized to establish a logical relationship between the problem, expected outcome, and service sets or interventions/orders. Plan of care template set 501 represents a grouping of individual plan of care templates 511-514 into logical combinations, which collectively address a more general patient need, such as an existing condition or safety concern. As shown in FIG. 5, each individual plan of care template consists of pre-coordinated problem data, pre-coordinated expected outcome data, and service or service set data. Pre-coordinated data is predefined data that is already assigned to a particular plan of care. For example, plan of care template 511 includes component data: (a) pre-coordinated problem data 521; (b) pre-coordinated expected outcome data 531; and (c) service or service set data 541. Clinical care category 560 provides the categorization data used by the clinical application to determine how to visually organize the components on a display categorically. FIG. 5 further depicts the hierarchy, as well as other interrelationships that exist within plan of care template 501. Metadata 550 is collected for each plan of care template and plan of care template set.

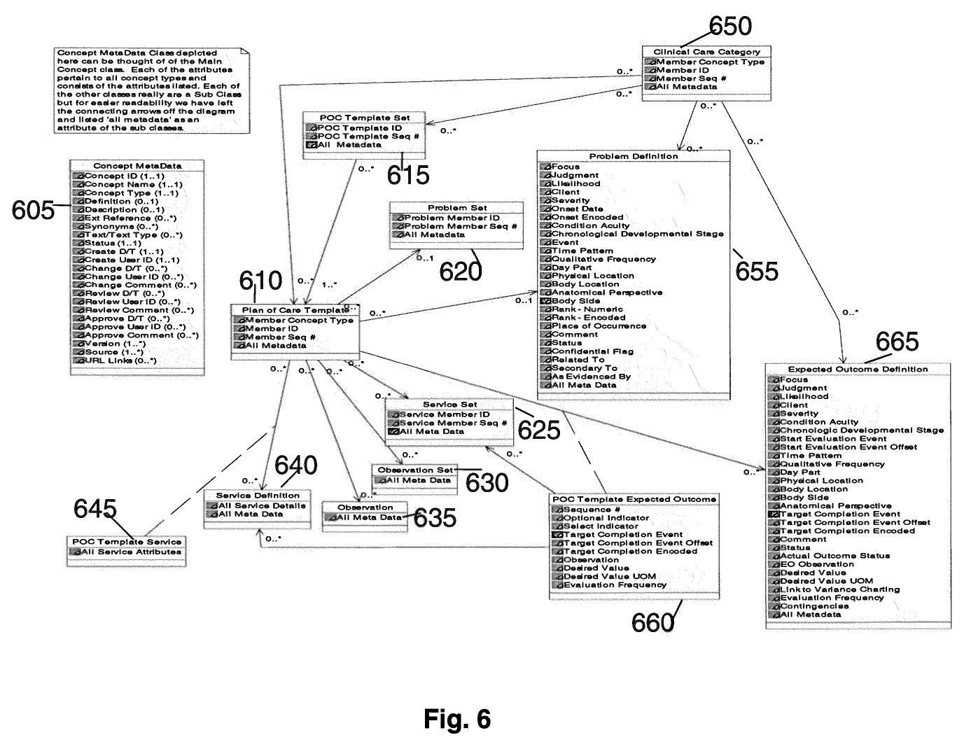

FIG. 6 depicts a plan of care definition model showing a more detailed interaction between a particular plan of care template and its corresponding component parts. Shown in FIG. 6 are the different attributes of each particular component.

Concept metadata table 605 shows metadata attributes which are common concepts in the model.

Plan of care template table 610 shows the attributes underlying the plan of care name. Plan of care template table 610 is linked to other tables described below. The links are depicted by solid black lines. Plan of care template table 610 is linked to the other tables because a plan of care template is the central data that provides the foundation for an interdisciplinary plan of care system on the basis of other data depicted in the other tables.

Plan of care template set table 615 shows the attributes underlying a plan of care set.

Problem set table 620 shows the attributes underlying a problem set associated with a plan of care template.

Service set table 625 shows the attributes underlying a service set associated with a plan of care template.

Observation set table 630 shows the attributes underlying an observation set associated with a plan of care template.

Observation table 635 shows the attributes underlying an observation associated with a plan of care template.

Service definition table 640 shows the attributes underlying service definitions associated with a plan of care template.

Plan of care template service table 645 shows the attributes underlying a service template associated with a service definition.

Clinical care category table 650 shows the attributes underlying a clinical care category associated with a plan of care template or a plan of care template set.

Problem definition table 655 shows the attributes underlying a problem associated with a plan of care template or clinical care category.

Plan of care template expected outcome table 660 shows the attributes underlying a template for an expected outcome, associated with a plan of care template, service set, or service definition.

Expected outcome definition table 665 shows the attributes underlying an expected outcome associated with a plan of care template or clinical care category.

A particular plan of care template name data is based upon the component parts of the plan and the attributes in the underlying information model. The problem name is the first word in a plan of care template name. If there is a cause or related diagnosis, the value of the second to nth word is the cause or related diagnosis, enclosed in parentheses. For example, if problem name data comprises “Gas Exchange Impairment,” and if the cause or related diagnosis is “Asthma,” then the plan of care template name value is set to “Gas Exchange Impairment (Asthma Adult).”

The plan of care model provides the foundation for creating a data-directed plan of care for patients. The definitional model defines the required relationships between problems, expected outcomes, and services. For example, the problem Nutrition Deficit is related to the expected outcome Adequate Nutrition. In order to meet the expected outcome, services are ordered. These services may be: Provide Dietary Supplement, Weight Every Day, Perform Calorie Count. The plan of care model supports the ability to group the problem, Nutrition Deficit with the expected outcome, Adequate Nutrition with the services: Provide Dietary Supplement, Weight Every Day, and Perform Calorie Count to provide the end user with the ability to create an organization-defined plan of care with other related problems, expected outcomes, and services.

The definition model further allows for the grouping of several problems, expected outcomes, services, and plans of care into logical combinations to address a more general patient need. For example, patients that are admitted for inpatient surgery may have the following problems: Knowledge Deficit, Infection Risk, Anxiety, and Fear. The model groups these problems with their related expected outcomes: Increased Knowledge, No Infection, Decreased Anxiety, and No Fear. In addition, services, or interventions/orders pertinent to addressing these outcomes are also grouped with the problems and expected outcomes. This grouping may be named a perioperative patient plan set.

In addition, the definition model groups similar problems, expected outcomes, services, and plan of care templates by discipline, body system or any other desirable grouping. This categorization can be used by the clinical application to visually organize the components on a display. Clinical care category data enables System 10 to effectively categorize and visually organize the components. For example, a respiratory therapist may want to see the problems defined within the Respiratory Clinical Care Category such as Respiration Alteration, Airway Clearance Impairment, Breathing Pattern Impairment, Gas Exchange Impairment, and Ventilatory Weaning Impairment. A physical therapist may want to see the problems defined by Mobility Clinical Care Category, such as Physical Mobility Impairment and Musculoskeletal System Alteration. A nutritionist may want to see those problems addressed by the Nutrition Clinical Care Category, such as Swallowing Impairment and Nutrition Alteration. A nurse may want to see problems unfiltered and uncategorized. Thus, problem data is defined to appear in one or more clinical care categories data in order to facilitate the display of a list of problems that are pertinent to a particular user's task for a particular patient.

The definition model further allows a user to over-ride the attributes of components when the component is included in a specific plan of care template instance. For example, the same expected outcome, “Patient will verbalize understanding of disease process,” may be included in more than one plan. In one plan, target completion may be 2 days, while in another, it may be 1 day. Expected outcome data may further be designated within plan of care data as optional, mandatory, or pre-selected.

Metadata attributes are common concepts in the model. They provide additional information to describe the concept. Concept name provides a meaningful, unambiguous text string to represent a concept. The concept name needs to be individual within concept types.

Concept ID is a name used by applications for processing. An example of a concept ID for the unit of measure concept minutes is MIN. Applications recognize and correctly process minutes because the applications recognize the concept ID MIN.

Concept type defines the term type for a specific term. An individual term may be associated with more than one term type. For example, a term with the name WBC may operate as a service as well as an observation.

Description provides text describing or defining a concept.

External references are mechanisms used to associate external terminology and interface identifiers to concepts, as well as direct application logic. An external reference name is the name by which an entity, or other system, industry-standard terminology source, or content source, recognizes the concept.

Synonyms provide multiple names to be defined for one concept. This facilitates searching for a concept. A synonym is not used as the display name.

Text/TextType is text that may be any value appropriate in relationship to the text role code. The term text entity contains additional text about a specific concept and concept type.

Status indicates whether the concept is active or inactive.

Create D/T provides the date and time the concept was created.

Create user provides the user identifier or program of the concept creator.

Change D/T provides the date and time the term was most recently changed.

Change User ID provides the user identifier or program that last changed the concept.

Change Comment provides free text comments related to the revision.

Review D/T provides the date and time the term was reviewed.

Review User ID provides the user identifier of the user who last reviewed the concept.

Review Comment provides free text related to the review of this concept definition.

Approve D/T provides the date and time the concept was approved.

Approve User ID provides the user identifier of the user who approved the concept.

Approve Comment provides free text related to the concept approval.

Version provides a specific identifier for the concept version.

Source provides the source of concept description/definition.

URL Link provides a reference or navigation that automatically brings the referred information to the user when the navigation element is selected by the user.

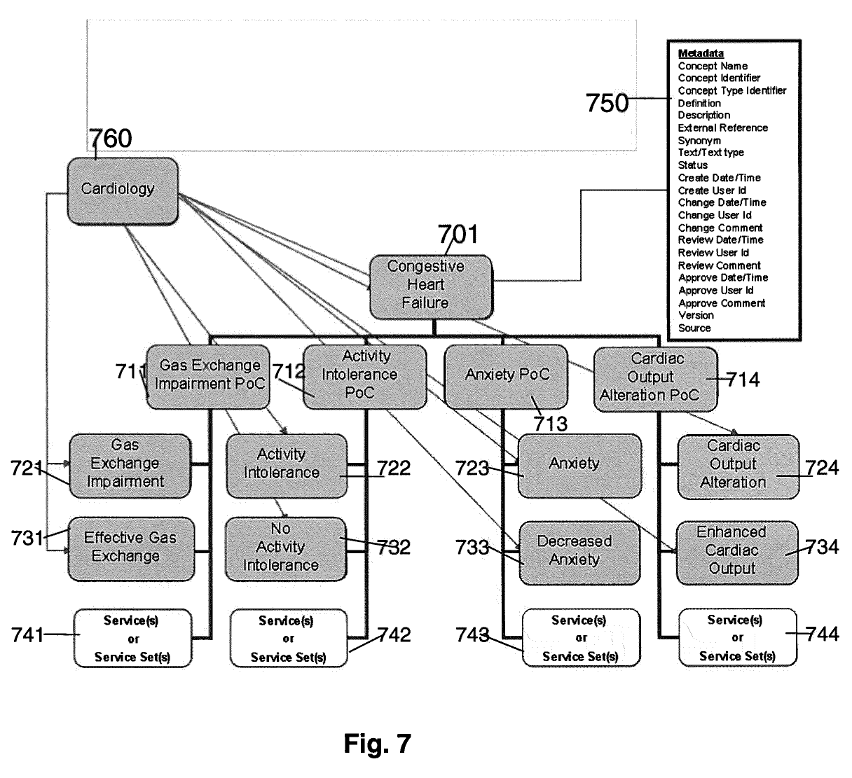

An example of how the plan of care definition model core components may be valued to create a plan of care definition instance is shown in FIG. 7. A plan or care includes at least problem data and service data. Expected outcome data is not a mandatory component within a plan of care definition, so the definition may be complete without expected outcome data. A grouping of plan of care template data constitutes a plan of care data set.

In FIG. 7, plan of care template set data field 701 is set to “Congestive Heart Failure.” The corresponding plan of care template data fields 711-714 are set where field 711 is set to “Gas Exchange Impairment Plan of Care,” field 712 is set to “Activity Intolerance Plan of Care,” field 713 is set to “Anxiety Plan of Care,” field 714 is set to “Cardiac Output Alteration.” Each plan of care template data field's corresponding component data fields is also defined. For example, problem data field 721 is set to “Gas Exchange Impairment” and expected outcome data field 731 is set to “Effective Gas Exchange.” Service data field 741 is set, but the specific value is not shown since more than one service may be set. Additionally, candidate care category data field 760 is set to “Cardiology” with corresponding component data fields 721. 722, 723, 724, 731, 732, 733, and 734 linked by solid lines. A candidate care category represents a grouping of problems, expected outcomes, or services that fall under a specific category. In this example, problem data fields 721, 722, 723, and 724, and expected outcome data fields 731, 732, 733, and 734 are associated with candidate care category data field 760, which is set to “Cardiology.” Categories are useful in a display image to display data relevant to that particular category. In FIG. 7, since the candidate care category is “Cardiology,” the associated problems and expected outcomes are relevant to a cardiologist or a healthcare worker in the field of cardiology.

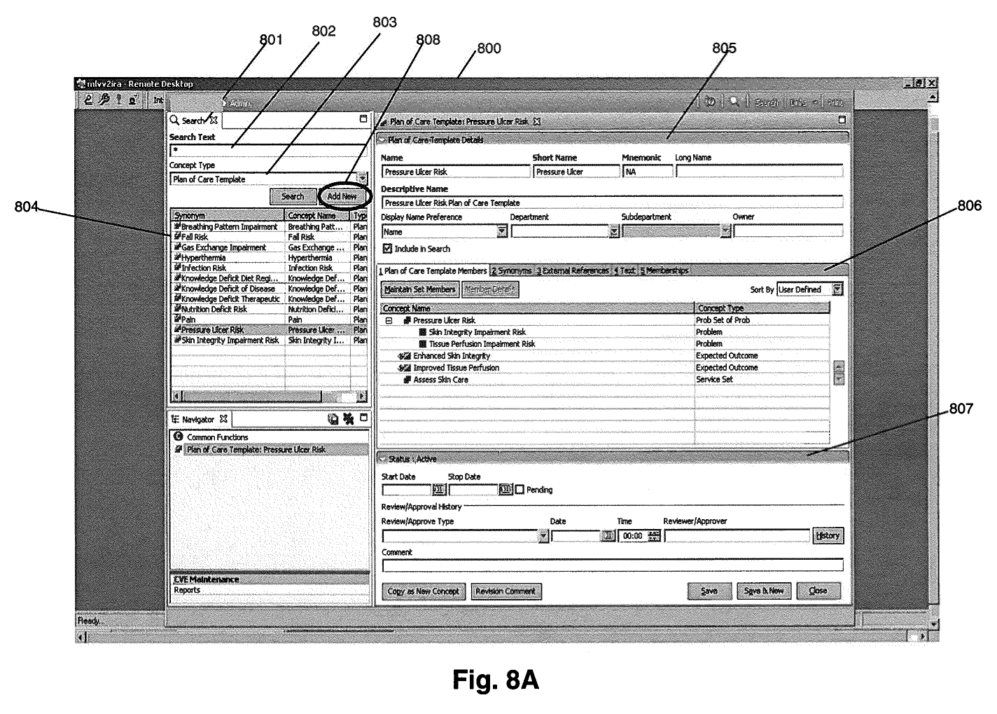

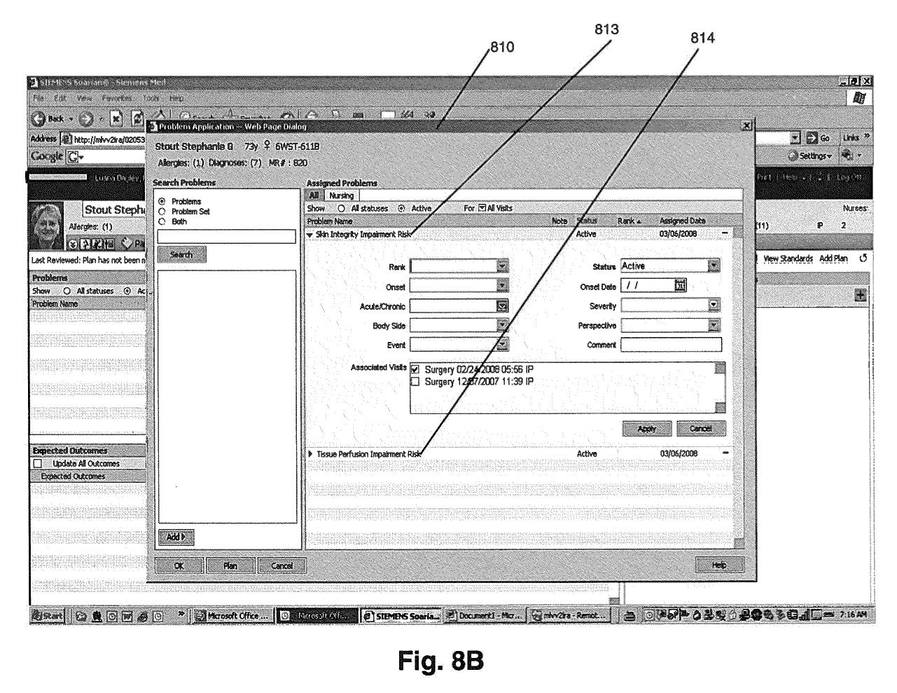

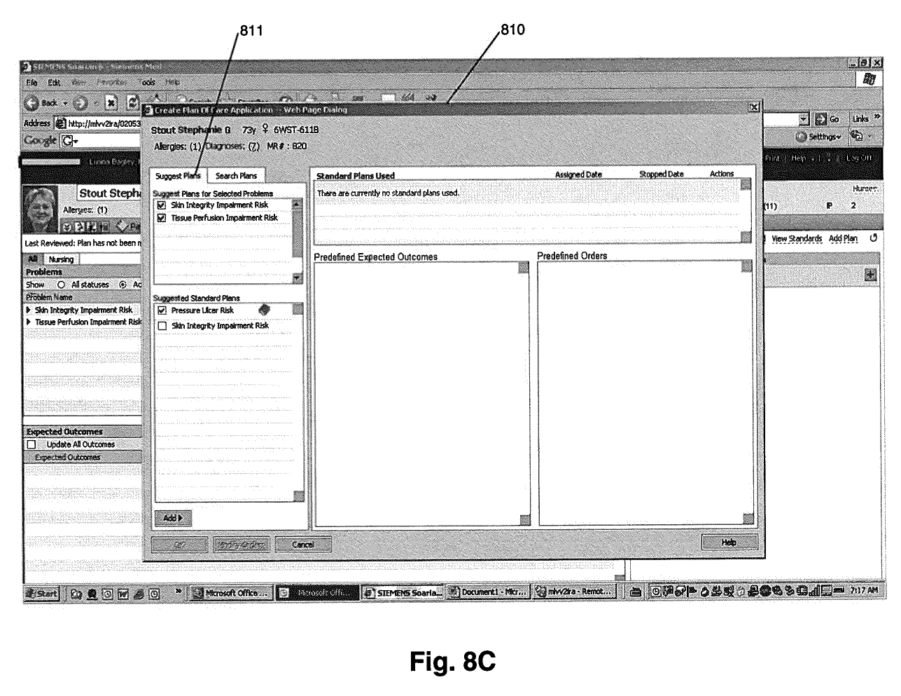

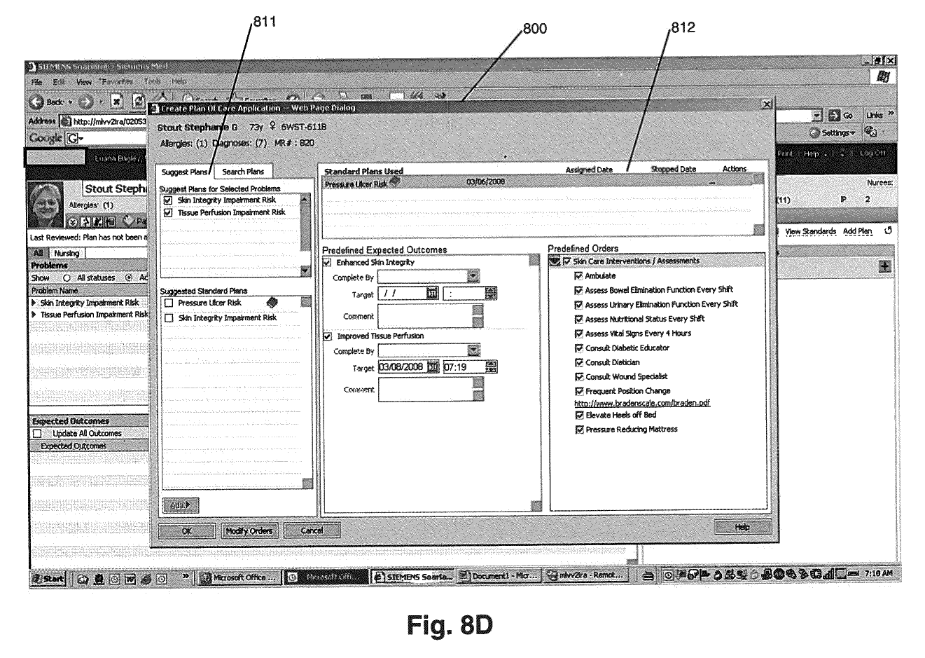

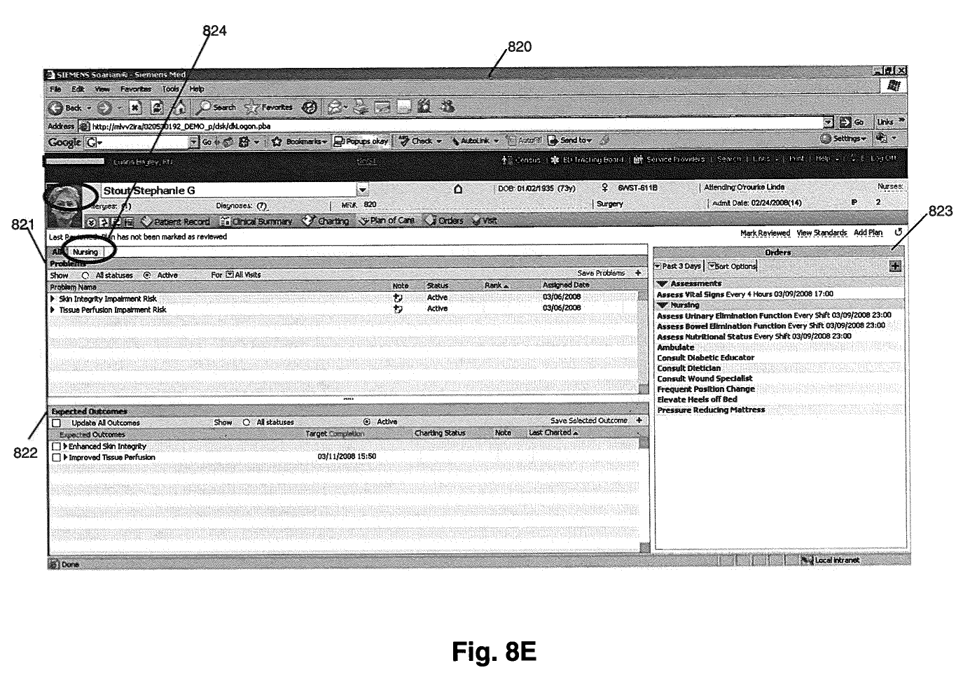

FIGS. 8A-8L illustrates in detail the interaction between the knowledge server (repository) of System 10 with the plan of care application interface and template builder. The screen shots in FIGS. 8A-8L illustrate an exemplary mechanism for constructing a plan of care model usable by a plurality of clinical applications within a healthcare information system. The screen shots in FIGS. 8A-8L include a display image provided by the user interface processor which have a plurality of sub-windows that enable a user to accomplish a particular task in creation of a plan of care model. The display window and sub-windows include at least one user selectable image element that enables the user to initiate, select and/or modify a particular data item in the plan of care model. In response to selection of particular image elements in either the display window or sub-windows, the user is able to initiate at least one of an executable procedure or instructions to perform the desired task.

When a plan of care is loaded and entered into the knowledge server or repository, the plan of care template screen shown in FIG. 8A is displayed for the user. The screen shot displayed in FIG. 8A includes display window 800 and enables a user to select, create and/or modify a plan of care model. Display window 800 includes a plurality of sub-windows providing a user with a composite display and enables the user to perform a plurality of different system functions from the same screen. Search window 801 includes a search field 802 whereby a user enters a search string used in searching the repository for plan of care models that match the user-entered search term. Search function is further enhanced by concept type field 803 which provides a drop down menu of candidate concept type for selection by a user in narrowing a search. In response to user activation of an image element initiating a search, matching data items are presented in results window 804. The results in window 804 list models by synonym, concept name and type. An example of system operation is described with respect to selection and/or modification of a plan of care for a Pressure Ulcer Risk. The selected plan of care and details describing the selected plan of care are present in details window 805. Details window 805 includes a plurality of user selectable and modifiable data fields that enable user customization and description of the particular plan of care. For example, details window 805 includes data fields defining (a) plan of care name, (b) short name for the plan of care, (c) a mnemonic associated with the plan of care and (d) long name for the plan of care. Additional data fields include a descriptive name, a candidate selection field determining the manner in which the care plan template is displayed in the system, a department and sub-department data field identifying areas in a healthcare enterprise responsible for treating the condition defined in the plan of care.

Display image 800 further includes definition window 806 that includes a plurality of user selectable tabs that enable a user to set data values for attributes associated with the plan of care. The tabs include (a) a template member tab, a synonym tab enabling a user to select synonyms for the plan of care template that are searchable by a user, an external reference tab enabling a user to add data values corresponding to external references associated with the plan of care, a text tab enabling user addition of free-form text to be associated with the plan of care and a membership tab enabling a user to define healthcare personnel to be associated with the plan of care. Exemplary operation of data values in the plan of care template member tab is described herein. The plan of care template member tab includes concept names and types associated with the plan of care. System assigns visual indicators for particular data values in the concept name field of this tab. For example, a blue square icon next to a concept name is used to indicate problems, such as skin integrity impairment risk and tissue perfusion impairment risk. A double blue square icon represents a problem set, which defines the set of patient problems which the displayed plan of care is associated with. Green square icons indicate expected outcomes, such as enhanced skin integrity and improved tissue perfusion. A double green square icon, if present, would represent sets of expected outcomes associated with the displayed plan of care. A double red square represents a service set, which is a set of interventions or orders that should be delivered as a part of a particular plan of care, such as assess skin care. When a user completes definition of a plan of care template, it is saved in a knowledge server or repository. FIG. 8A shows additional functionally such as an “add new” template button depicted by circle 808. Additional data fields are also displayed to allow a user to further customize a template plan of care.

FIG. 8B illustrates the screen shown when a patient problem is to be added to a particular patient record. In a plan of care template application, the first step in adding component parts, if component parts are needed, is to add a patient problem. Problems are entered first because plans of care, as discussed above, are problem-directed. Based on the entry of a problem, a code/identifier is associated with the problem to identify the problem, along with metadata, including who entered the problem, when it was entered, etc. In FIG. 8B, Stephanie Stout, a 73 year old female is the patient, with two problems shown, skin integrity impairment risk 813, and tissue perfusion impairment risk 814. Selection of either problem by a user results in a drop down area where corresponding data fields are shown. System 10 automatically presents candidate selections to the user enabling further definition of the patient problem being added. FIG. 8B allows a user to define a plurality of data fields associated with a given problem.

FIG. 8C is a screen shot including a patient specific display window 810 enabling association of an entered problem with a plan of care. Display window 810 includes a suggested plan window 811. Based on the problem(s) entered via the screen in FIG. 8B, candidate plans of care are listed for selection in suggested plan window 811. Also listed in suggested plan window 811 are a candidate list of standard plans that may be associated with the particular patient problems entered by the user. Data items in the suggested plan window 811 are determined by using the problem code associated with the problem. System 10 searches the repository for plans of care associated with the code or identifier. There may be more than one plan associated with a given problem, of which are subsequently displayed to a user in the suggested plans window 811. In this particular example, FIG. 8C displays one found plan for the problems of skin integrity impairment risk and tissue perfusion impairment risk. However, more than one plan may be displayed if more than one plan is found during the search.

FIG. 8D is a screen shot of patient specific display window 810 after a plan of care is selected for association with an entered patient problem. After a plan of care is selected, a user is prompted to define the plan of care. In FIG. 8D the plan of care is Pressure Ulcer Risk and is displayed in window 812. Content and rules for how a plan is displayed in window 812 and processed by system is directed by the attributes associated with the plan of care model. For example, what predefined orders are checked, as well as predefined expected outcomes that are available to define, are generally predefined when a user defines a plan of care template, which is discussed further below. A user may change predefined expected outcomes and predefined orders based to suit the particular patient's characteristics and ailments. A user of the system shown in FIG. 8D may, for example, change the problems, expected outcomes, or orders to tailor them to a particular patient's unique characteristics of a specific user's own preferences.

FIG. 8E is a display window 820 that is shown after the plan of care is assigned and modified. Display window 820 is composite display window that includes sub-windows identifying patient specific selected problems in a problem window 821, expected outcomes associated with the patient specific problems in expected outcome window 822 and any orders for patient treatment associated with the patient for the listed problems in orders window 823. In this example, a plan of care has been assigned to Stephanie Stout and has been posted to her patient record. Nursing, as shown by circle 824 in FIG. 8E, is the clinical care category defined for the problems and expected outcomes for the single plan posted for Stephanie Stout. Component data is shown in a user friendly single composite display image advantageously enabling quick review of pertinent patient specific data and care plan options.

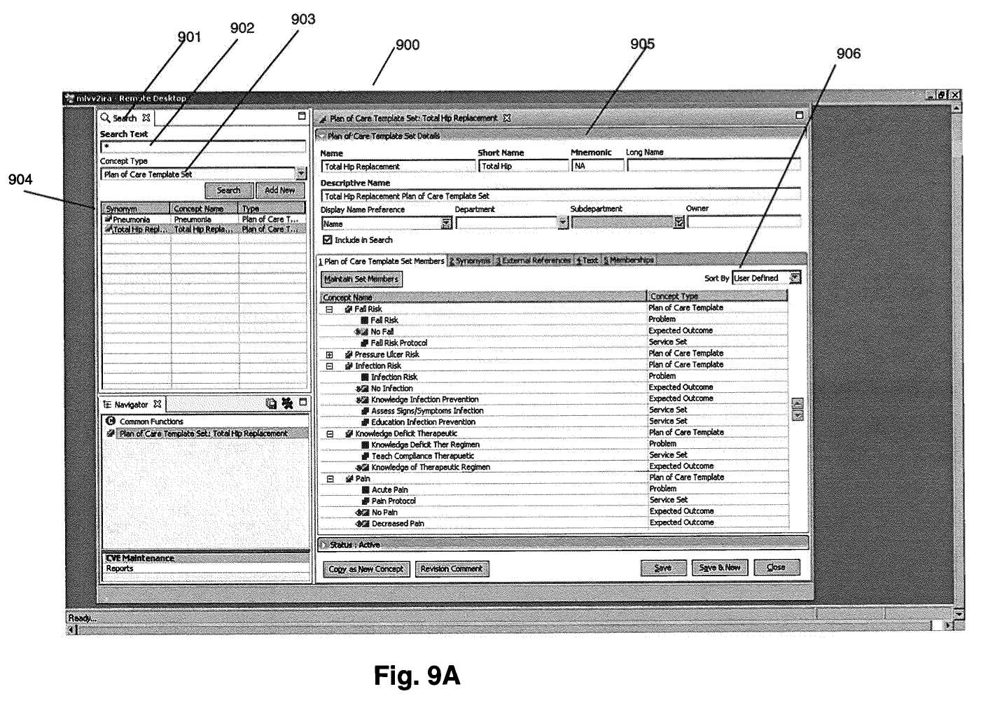

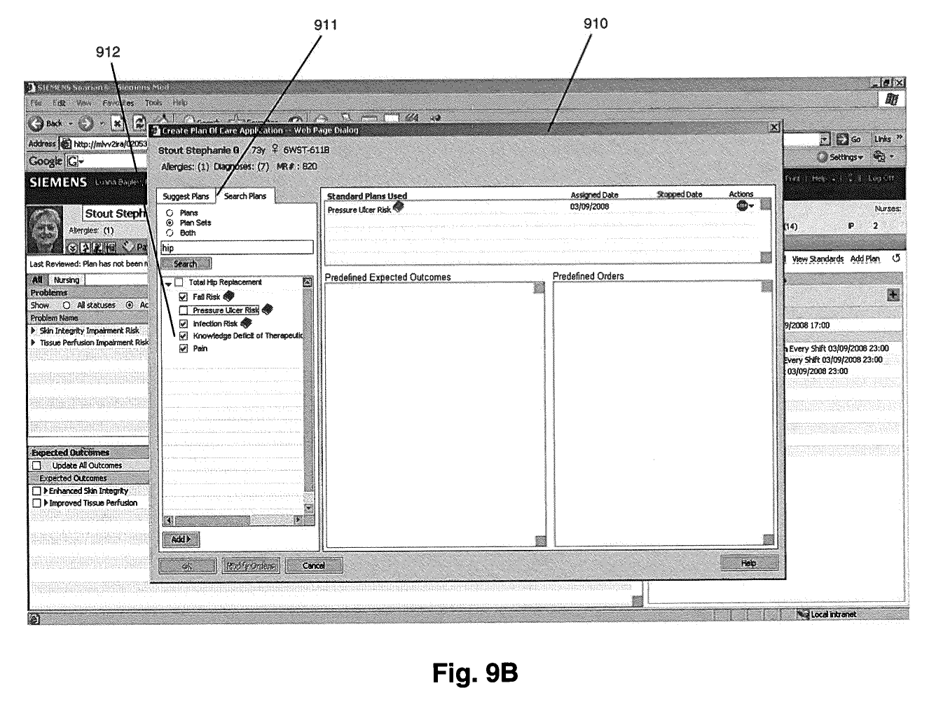

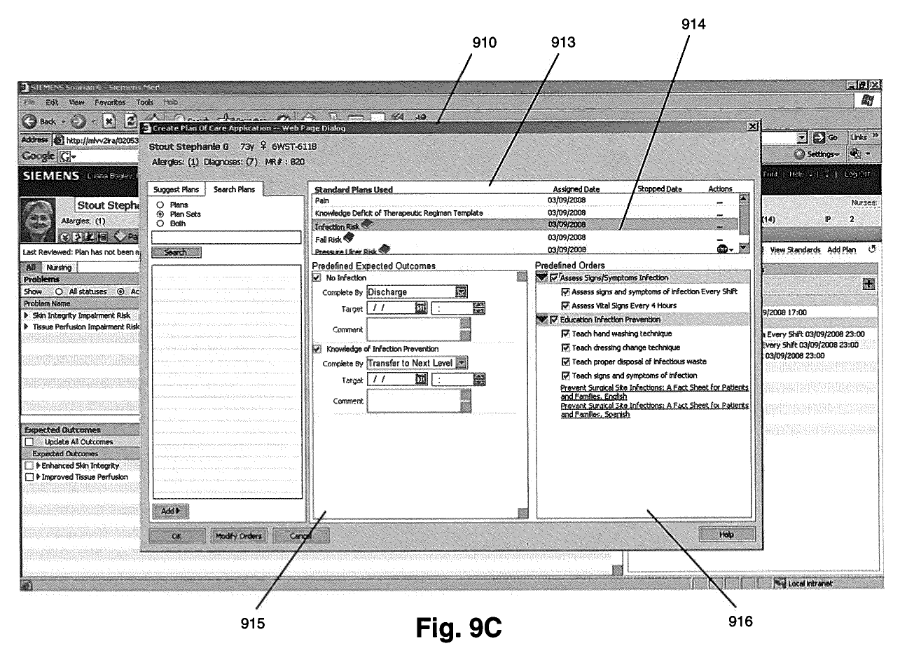

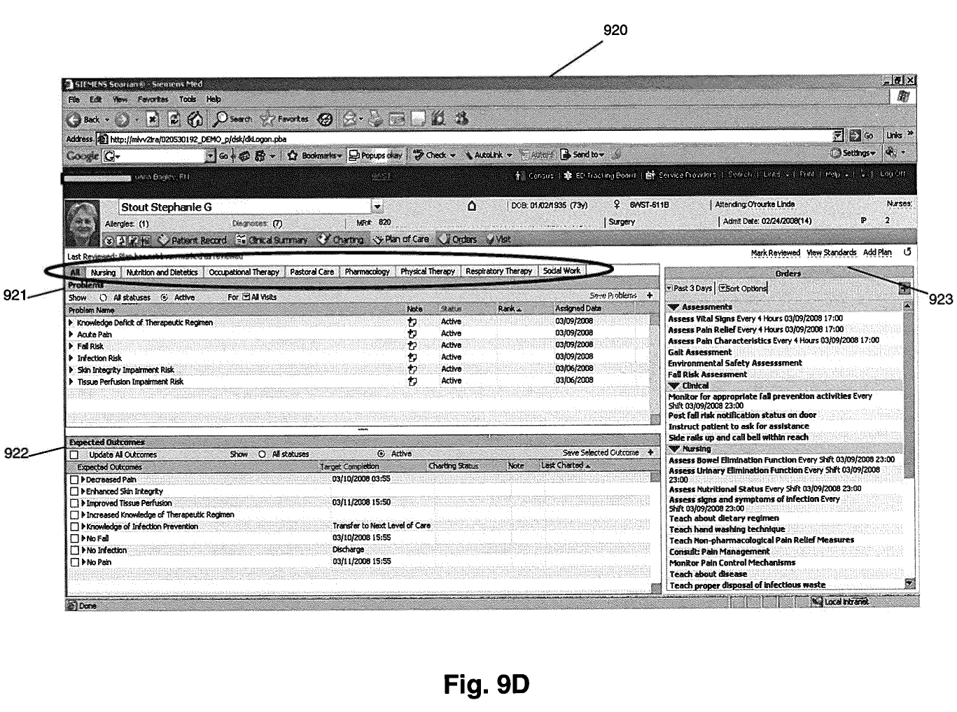

FIGS. 9A-9D illustrate exemplary screen shots for creating and/or modifying a plan of care using the plan of care template creation screen. The exemplary plan of care in FIGS. 9A-9D illustrate a more complicated plan of care for Total Hip Replacement. As shown, more components are displayed in the plan of care template set members display area than for the previous example described in FIGS. 8A-8E. Display image 900 includes a plurality of sub-windows providing a user with a composite display and enables the user to perform a plurality of different system functions from the same screen. Search window 901 includes a search field 902 whereby a user enters a search string used in searching the repository for plan of care models that match the user-entered search term. The search function is further enhanced by concept type field 903 which provides a drop down menu of candidate concept types for selection by a user in narrowing a search. In response to user activation of an image element initiating a search, matching data items are presented in results window 904. The results in window 904 list models by synonym, concept name and type. Herein, the search string entered in field 902 is “*” which searches the repository for any plan of care templates stored therein which are displayed in results field 904.

In this example, user has selected “Total Hip replacement” from the results window and plan of care details are displayed in details window 905. Details window 905 includes a plurality of user selectable and modifiable data fields that enable user customization and description of the particular plan of care. For example, details window 905 includes data fields defining (a) plan of care name, (b) short name for the plan of care, (c) a mnemonic associated with the plan of care and (d) long name for the plan of care. Additional data fields include a descriptive name, a candidate selection field determining the manner in which the care plan template is displayed in the system, a department and sub-department data field identifying areas in a healthcare enterprise responsible for treating the condition defined in the plan of care. Display window 900 further includes definition window 906 that includes a plurality of user selectable tabs that enable a user to set data values for attributes associated with the plan of care. The tabs include (a) a template member tab, a synonym tab enabling a user to select synonyms for the plan of care template that are searchable by a user, an external reference tab enabling a user to add data values corresponding to external references associated with the plan of care, a text tab enabling user addition of free-form text to be associated with the plan of care and a membership tab enabling a user to define healthcare personnel to be associated with the plan of care. Exemplary operation of data values in the plan of care template member tab is described herein. The plan of care template member tab includes concept names and types associated with the plan of care. The concepts listed in window 906 include any of plan of care templates associated with a specific patient problem, expected outcome data, patient problem data and service set data for providing services to patients for the particular patient problem. System assigns visual indicators for particular data values in the concept name field of this tab in a manner similar to that described with respect to FIG. 8A. FIG. 9A shows a plan of care that is comprised of at least one plan of care template for at least one patient problem associated with a patient undergoing a total hip replacement.

FIG. 9B is a screen shot of display window 910 enabling selection of a plan of care from a list of suggested plan of care templates for a particular patient. In this example, a user has entered the term “hip” in search field 911 and, in response to a search performed by system 10, the results including template care plans including the term “hip” are displayed in results window 912. Total hip replacement includes the set of problems as shown in window 912 as the indented text under “Total hip Replacement.” A user can selectively choose any or of the candidate plans of care listed in window 912 to be associated with the particular patient.

FIG. 9C is a screen shot of display window 910 including the plans of care selected in FIG. 9B. A display window 913 includes the standard plans of care selected and used for a particular patient problem. Display window 913 is selectively navigable by a user, for example, via a scroll function, to select and choose between different plans within a plan set. A user is able to highlight a plan 914 to modify any data associated with the plan. Upon selection, data representing predefined expected outcomes is automatically populated in expected outcome window 915 and data representing predefined orders to be placed for the patient are automatically populated in a predefined order window 916. FIG. 9D is a display window 920 that is shown after the plan of care is assigned and modified. Display window 920 is composite display window that includes sub-windows identifying patient specific selected problems in a problem window 921, expected outcomes associated with the patient specific problems in expected outcome window 922 and any orders for patient treatment associated with the patient for the listed problems in orders window 923. In this more complex plan for Stephanie Stout, additional clinical care categories exist, as illustrated by the circle in FIG. 9D. The clinical categories circled are: nursing, nutrition and dietetics, occupational therapy, pastoral care, pharmacology, physical therapy, resistance therapy, and social work. The information displayed as well as the category associations are based upon discrete problem definitions within the plan of care definition. Categories are selectable to display data relevant to that specific category. This feature is particularly useful when a particular healthcare user wants to see information or data that is relevant to his or her specialty.

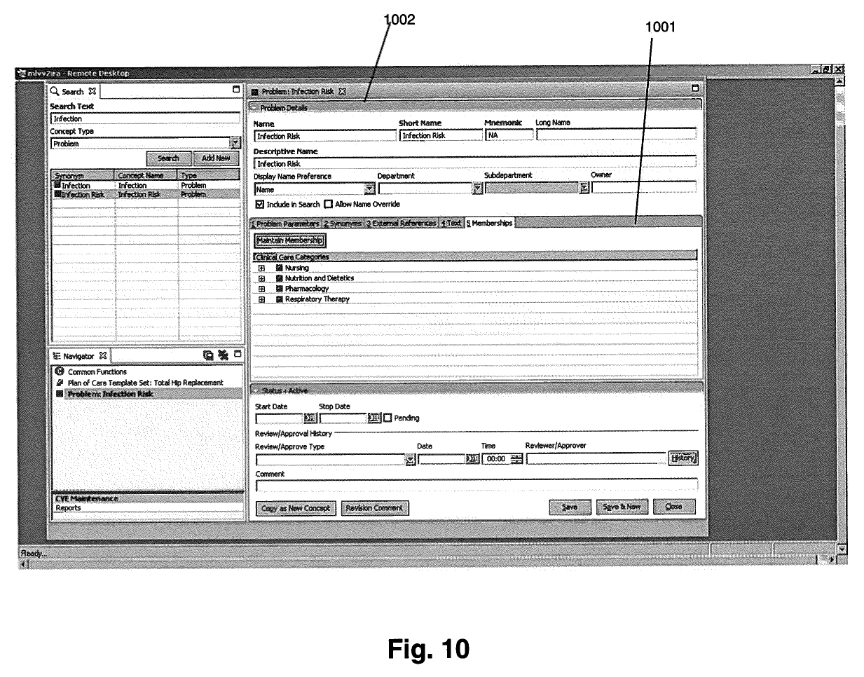

FIG. 10 is a display window 1000 that includes similar sub-windows as described above with respect to FIGS. 8C and 9B. In this exemplary display window, the membership tab of the details window 1001 is selected and may be modified by the user. The membership tab enables a user to select different clinical care categories to be assigned to (or removed from) the particular plan of care listed in the details window 1002. In this example, if a user were to select the membership tab, an area would be displayed allowing a user to select or unselect clinical care categories associated with a problem. In FIG. 10, four clinical categories (nursing, nutrition and dietetics, pharmacology and respiratory therapy) are associated with the problem of infection risk.

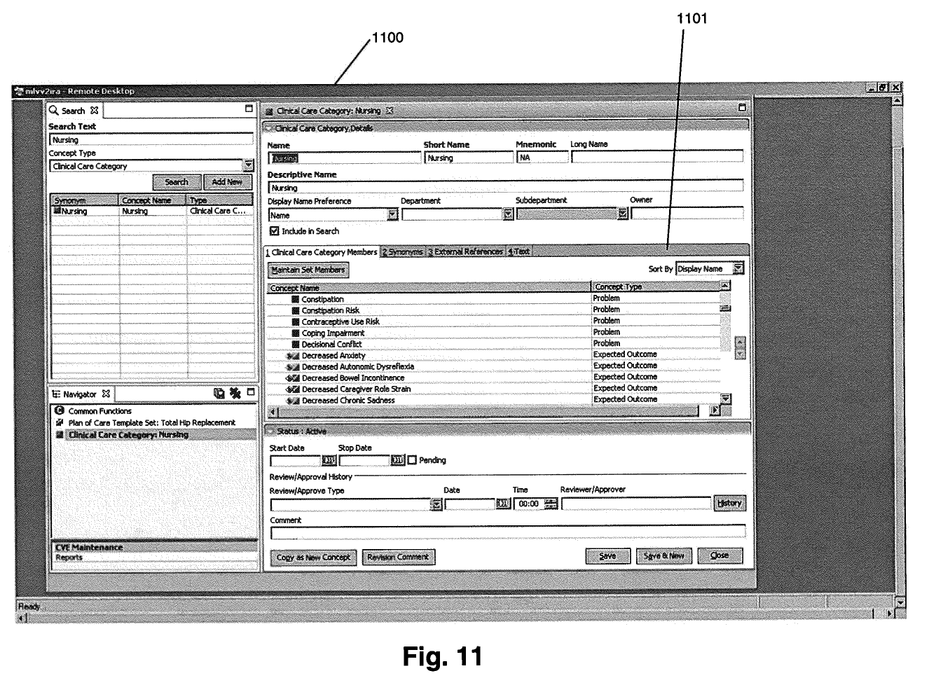

FIG. 11 is a display window 1100 illustrating an exemplary user interface for assigning concepts to a clinical care category. In this example, the clinical category is nursing, and various assigned concepts, or components, are listed for a user to view in details window 1101.

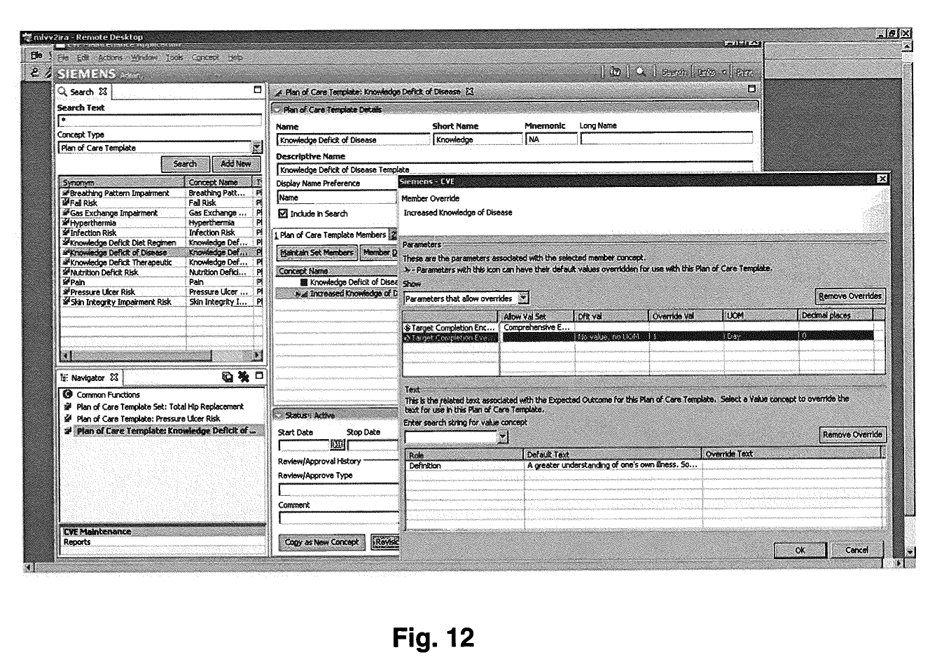

FIG. 12 illustrates the screen that is displayed when the system assigns an override to a problem, expected outcome, or order definition relevant to the plan of care in which they are used. In this example, the same expected outcome “patient will verbalize understanding of the disease” may be included in multiple plans. However, different plans may have different target completion dates. This screen allows an alteration of the plan of care definition that will display in a user's user interface.

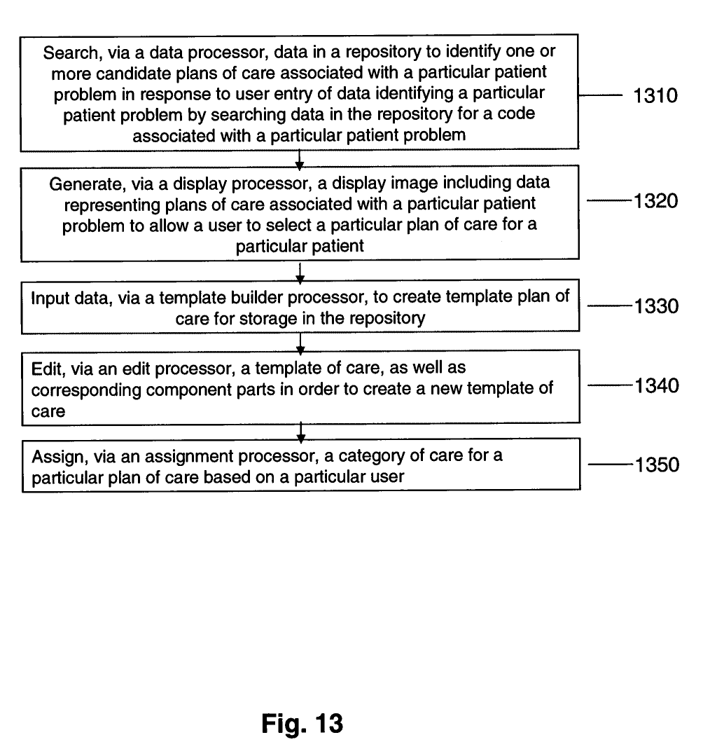

FIG. 13 is a flow diagram detailing operation of automated interdisciplinary plan of care generation system 10 shown in FIG. 1. Automated interdisciplinary plan of care generation system 10 provides for generation of plans of care for patients based upon processing of data stored in a repository representing particular patient problems and their associations with plans of care. In step 1310, a data processor searches data in a repository to identify one or more candidate plans of care associated with a particular patient problem in response to user entry of a data identifying a particular patient problem by searching data in the repository for a code associated with a particular patient problem. In addition, the data processor searches data in the repository to identify particular patient problems and one or more candidate plans of care associated with an identified patient problem by searching data in the repository in response to: (a) user entered data identifying a clinical observation; (b) user entered data identifying an expected outcome of patient treatment according to a plan of care; (c) user entered data identifying a treatment to be administered to a patient in a plan of care; (d) user entered data identifying patient demographic information. A repository, electrically coupled to the data processor, in one embodiment, includes data representing a plurality of different non-patient specific plans of care associated with a plurality of different patient problems. An individual plan of care is formed by component parts which include patient problems, expected outcomes, clinical observations, and orders for treatment to be administered to a patient.

A display processor, in step 1320, coupled to the data processor, generates a display image including data representing plans of care associated with a particular patient problem to allow a user to select a particular plan of care for a particular patient.

In step 1330, a template builder processor, electrically coupled to the data processor, enables a user to input data in order to create a template plan of care for storage in the repository. Since a patient problem is mandatory in order for there to be a plan of care, the problem is either entered by the user or retrieved from the repository to be associated with the plan of care template name entered by a user.

In step 1340, an edit processor, electrically coupled to the template builder processor, allows the user to edit a template of care as well as its corresponding expected outcomes, observations, and orders for treatment to create a new template of care. In step 1350 an assignment processor assigns a particular user a category of plans of care based on at least one of: (a) user identification information; and (b) user role. The category is then applied to a particular plan of care template created or edited by a user.

The system and processes of FIGS. 1-13 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, the processes and applications may, in alternative embodiments, be located on one or more (e.g., distributed) processing devices on the network of FIG. 1.

What is claimed is:

1. A processing device implemented system supporting providing a plan of care for a patient, comprising:
a repository including data representing a plurality of different non-patient specific plans of care associated with a plurality of different patient problems and including data representing an individual plan of care, indicating care to be provided to a specific patient, associated with a patient problem, an expected outcome, clinical observations and orders for treatment to be administered to a patient;
a data processor for searching data in said repository to identify one or more candidate plans of care associated with a particular patient problem in response to user entry of data identifying said particular patient problem by searching data in said repository for a code associated with said particular patient problem; and
a display processor for generating data representing at least one display image including data representing said one or more candidate plans of care associated with said particular patient problem enabling a user to select a particular plan of care for a particular patient.

2. A system according to claim 1, including
a rules processor for applying predetermined rules of different types associated with corresponding different patient problem characteristics in identifying said one or more candidate plans of care associated with a particular patient problem.

3. A system according to claim 1, wherein
said data processor uses mapping information to map said particular patient problem to said code associated with said particular patient problem to identify said code associated with said particular patient problem.

4. A system according to claim 1, wherein
said code comprises at least one of, a concept name and a concept identifier.

5. A system according to claim 1, wherein
said data processor searches data in said repository to identify particular patient problems and one or more candidate plans of care associated with an identified patient problem by searching data in said repository in response to user entered data identifying a clinical observation.

6. A system according to claim 1, wherein
said data processor searches data in said repository to identify particular patient problems and one or more candidate plans of care associated with an identified patient problem by searching data in said repository in response to user entered data identifying an expected outcome of patient treatment according to a plan of care.

7. A system according to claim 1, wherein
said data processor searches data in said repository to identify particular patient problems and one or more candidate plans of care associated with an identified patient problem by searching data in said repository in response to user entered data identifying a treatment to be administered to a patient in a plan of care.

8. A system according to claim 1, wherein
said repository includes data associating patient demographic information with said plurality of different plans of care and
said data processor searches data in said repository to identify one or more candidate plans of care associated with a particular patient problem by searching data in said repository in response to user entered data identifying a patient demographic information.

9. A system according to claim 1, wherein
said patient demographic information comprises one or more of, (a) age, (b) gender, (c) weight, (d) height and (f) pregnancy status.

10. A system according to claim 1, wherein
said repository comprises one or more databases.

11. A system according to claim 1, wherein
said repository includes data representing a set of plans of care comprising a plurality of different plans of care associated with at least one particular patient problem.

12. A system according to claim 1, wherein
said repository includes data representing a set of treatments to be administered to a patient in a plan of care associated with a particular patient problem.

13. A system according to claim 1, wherein
said repository includes data representing a set of clinical observations associated with a particular patient problem.

14. A system according to claim 1, wherein
said repository includes data representing a set of patient problems associated with said individual plan of care.

15. A system according to claim 1, wherein
said repository comprises,
a first repository including data representing a plurality of different non-patient specific plans of care associated with a plurality of different patient problems and
a second repository including data representing an individual plan of care, indicating care to be provided to a specific patient, associated with a patient problem, an expected outcome, clinical observations and orders for treatment to be administered to a patient, and
said data processor searches data in said first and second repository to identify one or more candidate plans of care.

16. A processing device implemented system supporting providing a plan of care for a patient, comprising:
a template builder processor enabling a user to generate data representing a template plan of care for storage in a repository;
a repository, electrically coupled to said template builder processor, including data representing a plurality of different template plans of care associated with a plurality of different patient problems and an individual template plan of care indicates care to be provided to a patient and is associated with a patient problem, a plurality of expected outcomes, clinical observations and orders for treatment to be administered to a patient;
a data processor, electrically coupled to said repository, for searching data in said repository to identify one or more candidate template plans of care associated with a particular patient problem in response to user entry of data identifying said particular patient problem by searching data in said repository for a code associated with said particular patient problem; and
a display processor, electrically coupled to said data processor, for generating data representing at least one display image including data representing said one or more candidate template plans of care associated with said particular patient problem enabling a user to select a particular plan of care for a particular patient.

17. A system according to claim 16, wherein
said data processor automatically adaptively selects said orders for treatment to be associated with a plan of care in response to context information.

18. A system according to claim 17, wherein
said context information comprises at least one of, (a) patient specific clinical data, (b) patient specific demographic data, (c) type of plan of care, (d) patient specific genomic data and (e) patient specific proteomic data.

19. A system according to claim 16, wherein
said data processor automatically adaptively selects said expected outcomes to be associated with a plan of care in response to context information.

20. A system according to claim 17, wherein
said context information comprises at least one of, (a) patient specific clinical data, (b) patient specific demographic data and (c) type of plan of care.

21. A system according to claim 16, including
an assignment processor for assigning a particular user a particular category of plans of care based on at least one of, (a) user identification information and (b) user role.

22. A system according to claim 21, wherein
plans of care are categorized by at least one of, (a) cancer type, (b) heart disease, (c) nursing, (d) physician specialty, and (e) molecular pathway associated with a clinical condition.

23. A system according to claim 16, including
an assignment processor for assigning a particular user a particular category of patient problems based on at least one of, (a) user identification information and (b) user role.

24. A system according to claim 16, including
an edit processor enabling a user to edit a template plan of care accessed from said repository to create a new template plan of care for storage in said repository.

25. A system according to claim 24, wherein
said edit processor enables a user to edit values representing expected outcomes in a patient template plan of care to create a new template plan of care for storage in said repository.

26. A system according to claim 24, wherein
said edit processor enables a user to edit values representing clinical observations in a patient template plan of care to create a new template plan of care for storage in said repository.

27. A system according to claim 24, wherein
said edit processor enables a user to edit values representing orders for treatment to be administered to a patient in a patient template plan of care to create a new template plan of care for storage in said repository.

28. A processing device implemented system supporting providing a plan of care for a patient, comprising:
a template builder processor enabling a user to generate data representing a template plan of care for storage in a repository;
a repository, electrically coupled to said template builder processor, including data representing a plurality of different template plans of care associated with a plurality of different patient problems and an individual template plan of care indicates care to be provided to a patient and is associated with a patient problem, an expected outcome, clinical observations and orders for treatment to be administered to a patient;
a data processor for searching data in said repository to identify one or more candidate template plans of care associated with a particular patient problem in response to user entry of data identifying said particular patient problem by searching data in said repository for a code associated with said particular patient problem;
an edit processor enabling a user to edit a candidate template plan of care accessed from said repository to create a new template plan of care for storage in said repository; and
a display processor for generating data representing at least one display image including data representing said new template plan of care associated with said particular patient problem selectable by a user for a particular patient.
